(19) United States
(12) Patent Application Publication
(10) Pub. No.: US 2026/0192573 A1
(43) Pub. Date: Jul. 9, 2026

(54) METHOD AND SYSTEM FOR PRINTING ON CARD LABELS

(71) Applicant: Entrust Corporation, Shakopee, MN (US)

(72) Inventors: Tom WAGENER, Shakopee, MN (US); Brendan HINNENKAMP, Shakopee, MN (US); Jon WAWRA, Shakopee, MN (US); Geoff THORNTON, Shakopee, MN (US)

(21) Appl. No.: 19/439,961

(22) Filed: Jan. 5, 2026

Related U.S. Application Data
(60) Provisional application No. 63/743,086, filed on Jan. 8, 2025.

(51) Int. Cl. B41J 3/407; B41J 3/60; B41J 11/00; B41J 13/12

(52) U.S. Cl. CPC B41J 3/4075; B41J 3/60; B41J 11/00214; B41J 13/12

(57) ABSTRACT

Methods and systems for printing on a label after it has been applied to the surface of a card. With the label applied to the card surface, the label and at least a portion of the card surface separate from the label may be printed in a print station in a single printing pass of the card through the print station. This eliminates the need for a second print station to achieve the printing on the label and the card surface, and eliminates the need to return the card back through the print station in a second printing pass to print on the label and the card surface.

### PRIORITY

This application claims the benefit of priority to U.S. Provisional Application No. 63/743086, filed on Jan. 8, 2025, the entire contents of which are incorporated herein by reference.

### FIELD

This technical description is directed to methods and systems for printing on labels applied on cards, in particular on personalized cards.

### BACKGROUND

When a card, such as a financial card, for example a credit card, a debit card, or the like, is mailed to the intended recipient of the financial card, a card activation label is typically applied to the financial card prior to mailing the financial card. The card activation label contains information, such as a telephone number and instructions for activating the financial card. By following the instructions on the card activation label the recipient can activate the financial card. The card activation label is adhered to the financial card with an adhesive that permits removal of the card activation label by the recipient. Labels may also be applied to cards, including financial cards, driver's licenses, identification cards, and other types of cards, for marketing purposes and purposes other than card activation.

The labels may be pre-printed, generic labels that are printed with the same information that are then applied to the cards. The labels may also be printed in real-time, including with printing that may be unique to the card or unique relative to other labels applied to other cards. U.S. Pat. No. 10,369,807 describes techniques for real-time printing of custom labels. The entire contents of U.S. Pat. No. 10,369,807 are incorporated herein by reference. Published U.S. patent application 2024/0351349 describes techniques for printing on a label while the label is adhered to the card. The entire contents of U.S. 2024/0351349 are incorporated herein by reference.

### SUMMARY

Methods and systems are described for printing on a label after it has been applied to the surface of a card such as a financial (e.g., credit, debit, or the like) card, driver's license, national identification card, and other type of card which bears or will bear personalized data unique to the intended cardholder and/or which bears other card information. In an embodiment, the card with the label applied may ultimately be mailed to the intended cardholder. In another embodiment, the card may be distributed directly to the intended cardholder who personally retrieves the card. The label can be used for any purpose including, but not limited to, activation of the card by the intended cardholder, marketing of products and/or services to the intended cardholder, a combination of activation and marketing, and other purposes.

In an embodiment, with the label applied to the card surface, the label and at least a portion of the card surface separate from the label may be printed in a print station in a single printing pass of the card through the print station. This eliminates the need for a second print station to achieve the printing on the label and the card surface, and eliminates the need to return the card back through the print station in a second printing pass to print on the label and the card surface.

The label may already have printing applied thereto, but additional printing is applied in the print station after the label is applied to the card surface. In another embodiment, the label may be blank when applied to the card surface and the printing applied in the print station is the first printing applied to the label.

The card surface may already have some printing applied thereto, but additional printing is applied in the print station. In another embodiment, the card surface may be blank (i.e. without previously applied printing) and the printing applied in the print station is the first printing applied to the card surface.

In an embodiment, a second printing pass through the print station can be implemented to apply additional printing on the label and/or the card surface to which the label is applied.

In an embodiment, a second printing pass through the print station can be implemented to print on the surface of the card opposite the card surface to which the label is applied. In this embodiment, the second printing pass may take place after flipping the card 180 degrees.

In an embodiment, a second label may be applied to the surface of the card opposite the card surface to which the first label is applied. In such an embodiment, the card may be flipped and returned back to the label applicator station (or just upstream thereof) to apply the second label to the opposite card surface. The card may then be processed like the original card surface and the first label, including printing on the second label and/or printing on the opposite card surface.

The print station may be configured as an inkjet printer to implement inkjet or drop-on-demand (DOD) printing using at least one inkjet or DOD printhead. Preferably multiple printheads are used. In an embodiment, the print station may be configured as a direct-to-card thermal printer that includes a thermal printhead and a thermal print ribbon.

The printing on the label and/or on the card surface to which the label is applied may be monochromatic (i.e. single color) of a desired single color such as black (K), yellow (Y), magenta (M), cyan (C), or specialty color such as red. In another embodiment, the printing on the label and/or on the card surface to which the label is applied may be multi-color such as CMYK. In an embodiment, another material, such as a varnish or other non-color material, may be applied by the print station onto the label and/or onto the card surface.

The printing on the label applied to the card may occur prior to the printing on the card surface. Alternatively, the printing on the card surface may occur prior to the printing on the label. Alternatively, at least some of the printing, or all of the printing, on the label applied to the card may occur simultaneously with at least some of the printing, or all of the printing, on the card surface.

In one embodiment, a method of printing on a label applied to a card in a card printing system, that comprises a print station with at least one printhead, is provided. The method comprises supplying to the printing system a card provided with a first surface and a label provided with a first face opposite a second face. Thereafter, the second face of the label is applied on the first surface of the card to apply the label to the card. Thereafter, with the label applied to the card surface, in a single printing pass through the print station, the first face of the label is printed on and a portion of the first surface of the card separate from the label is also printed on. Thereafter, the card is output from the card printing system.

In the single printing pass, the card may travel through the print station in a first direction,

and in the single printing pass the card does not travel in a second direction opposite the first direction.

In another embodiment, a method of printing in a card printing system that comprises an inkjet printer is provided. The method can comprise supplying to the card printing system a card provided with a first surface and a label provided with a first face opposite a second face. Thereafter, the second face of the label is engaged on the first surface of the card to apply the label to the card. Thereafter, a surface treatment may be performed on a portion of the first surface of the card without performing a surface treatment on the first face of the label applied to the card so that the first face of the label is untreated by the performed surface treatment. Thereafter, with the label applied to the card surface, the inkjet printer is used to print on the first face of the label and/or to print on the treated portion of the first surface of the card. Thereafter, the card may be output from the card printing system.

### DRAWINGS

FIG. 1 schematically depicts a card printing system described herein.

FIG. 2 depicts another embodiment of a card printing system described herein.

FIG. 3 is a perspective view of a card and a label to be applied to the card.

FIGS. 4A and 4B are plan views of a first card surface and a second card surface, respectively, opposite the first card surface, with a label applied to the first card surface.

FIGS. 5A and 5B are plan views of another embodiment of a first card surface and a second card surface, respectively, opposite the first card surface, with a first label applied to the first card surface and a second label applied to the second card surface.

### DETAILED DESCRIPTION

As described in further detail below, a label is printed on after it has been applied to the surface of a card such as a financial (e.g., credit, debit, or the like) card, driver's license, national identification card, and other type of card which bears or will bear personalized data unique to the intended cardholder and/or which bears other card information. The card with the label applied may ultimately be mailed to the intended cardholder. Or card may be distributed directly to the intended cardholder who personally retrieves the card. The printing on the label can be any type of printing including, but not limited to, information relating to activation of the card by the intended cardholder, marketing of products and/or services to the intended cardholder, a combination of activation and marketing information, a logo, graphics, and other printing.

With the label applied to the card surface, the label and at least a portion of the card surface separate from the label may be printed in a print station in a single printing pass of the card through the print station. This eliminates the need for a second print station to achieve the printing on the label and the card surface, and eliminates the need to return the card back through the print station in a second printing pass to print on the label and the card surface.

The card can be a card which may be made entirely of plastic, or a combination of plastic and non-plastic materials. In an embodiment, the card may be made entirely of non-plastic materials such as paper or metal. In an embodiment, the card may be made of a plastic such as polycarbonate, polyvinyl chloride (PVC), polyethylene terephthalate glycol (PETG), and other plastics. In an embodiment, the card may be an ID-1 card as defined by ISO/IEC 7810. However, other card formats such as ID-2 as defined by ISO/IEC 7810 are possible as well.

The card may be of a type that is personalized with personalization applied to the card. The term “personalization” (or the like) as used throughout the specification and claims, unless indicated otherwise, is intended to encompass operations performed on a card that includes operations that result in personalizing the card as well as operations that do not result in personalizing the card. An example of a personalization operation that personalizes the card is printing the intended card holder's image, name, or account number on the card. An example of a personalization operation that does not personalize the card is printing non-card holder graphics on the card. The term “personalize” is often used in the personalized card industry to refer to a card that undergoes both personalization processing operations and non-personalization processing operations.

The concepts described herein can be implemented in any suitable card printing system (also referred to as a card personalization system). One example of a type of card printing system that can be used is referred to as a central issuance card printing/personalization system that is typically designed for large volume batch processing of cards, often employing multiple processing stations or modules to process multiple cards at the same time to reduce the overall per card processing time. Examples of central issuance card personalization systems include the MX family of central issuance systems available from Entrust Corporation of Shakopee, Minnesota. Other examples of central issuance systems are disclosed in U.S. Pat. Nos. 4,825,054, 5,266,781, 6,783,067, and 6,902,107, all of which are incorporated herein by reference in their entirety.

Another example of a type of card printing system that can be used is referred to as a desktop card printing/personalization system that is typically designed for relatively small scale, individual card processing. In desktop card printing systems, a single card to be processed is input into the system, processed, and then output. These systems are often termed desktop machines or desktop printers because they have a relatively small footprint intended to permit the machine to reside on a desktop. Many examples of desktop machines are known, such as the SD or CD family of desktop card machines available from Entrust Corporation of Shakopee, Minnesota. Other examples of desktop card personalization systems are disclosed in U.S. Pat. Nos. 7,434,728 and 7,398,972, each of which is incorporated herein by reference in its entirety.

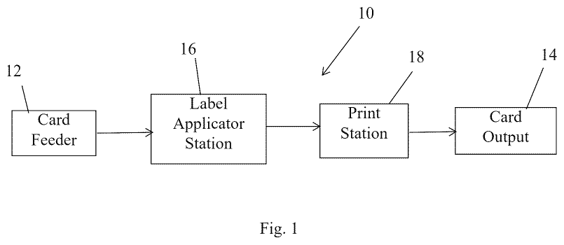

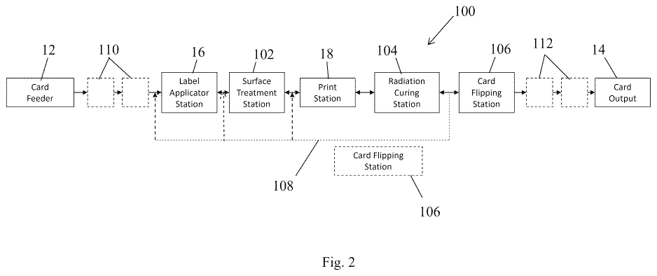

Referring to FIG. 1, an example of a card printing system 10 is illustrated schematically. In this example, the system 10 is depicted as including a card feeder 12, a card output 14, a label applicator station 16, and a print station 18. Other stations, such as those described below in FIG. 2 may also be present.

The card feeder 12 is configured to feeds cards one-by-one into the printing system 10 and the card output 14 is configured to receive the cards after they have been printed. The card feeder 12 can include a card input hopper designed to hold a plurality of cards waiting to be fed one-by-one into the system 10 for processing. An example of an input hopper is described in U.S. Pat. No. 6,902,107 which is incorporated herein by reference in its entirety. Alternatively, the card feeder 12 can be an input slot through which individual cards are fed one-by-one into the system 10. The card output 14 can be a card output hopper designed to hold a plurality of processed/printed cards that are output one-by-one after being processed within the system 10. An example of a card output hopper is described in U.S. Pat. No. 6,902,107 which is incorporated herein by reference in its entirety. Alternatively, the card output 14 can be an output slot through which individual cards are output one-by-one. In the case of central issuance card printing systems, the card output 14 can be the last element in the system 10 and located at the downstream end of the system 10. However, the card output 14 is not required in a central issuance card printing system and the processed cards can be output directly to an inserter mechanism that attaches the cards with the labels attached thereto to card carrier forms to create card/carrier combinations, folds the card/carrier combinations and inserts the card carrier combinations into envelopes for mailing to the intended recipients. In the case of desktop card processing systems, the card output 14 can be located at the downstream end of the system 10 in some systems, or even located at the same end of the system 10 as the card input 12.

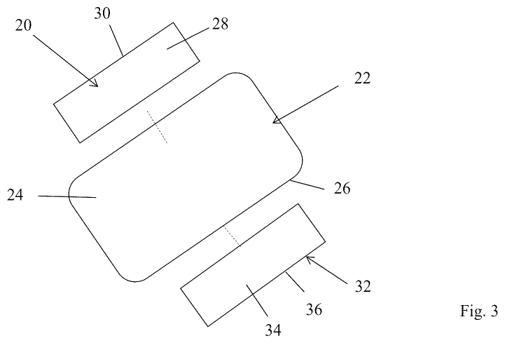

The label applicator station 16 is configured to receive a card that is input from the card feeder 12 and apply a label 20 to a surface of the card 22. An example of the card 22 is depicted in FIG. 3. The card 22 includes a first surface 24 and a second surface 26 opposite the first surface 24. The first surface 24 may be considered the front or rear surface of the card 22, while the second surface 26 may be considered the rear or front surface of the card 22. The label 20 includes a first face 28 and a second face 30 opposite the first face 28. Both surfaces 24, 26 of the card 22 may be printed on. The second face 30 of the label 20 includes an adhesive thereon that is used to removably adhere the label 20 to the first surface 24 of the card 22. The face 28 is the primary face of the label 20 that is intended to be printed on once the label 20 is adhered to the card surface 24. However, the face 30 may have printing previously applied thereto.

FIG. 3 also depicts an optional second label 32 that may be removably adhered to the second surface 26 of the card 22. The second label 32 includes a first face 34 and a second face 36 opposite the first face 34. If used, the first face 34 of the label 32 includes an adhesive thereon that is used to removably adhere the label 32 to the second surface 26 of the card 22. The face 36 is the primary face of the label 32 that is intended to be printed on once the label 32 is adhered to the card surface 26. However, the face 34 may have printing previously applied thereto.

Returning to FIG. 1, the label applicator station 16 is configured to apply the label 20 to the card surface 24 after removing the label 20 from a label holder support and engaging the label 20 on the card surface 24, in particular by engaging the face 30 of the label 20 on the surface 24 of the card 22. The label 20 is removably engaged to the card by an adhesive on the face 30. The adhesive can be pre-applied to the face 30 during the production of the label 20. If the label 32 is to be applied to the card surface 26, the label 32 can be applied in a similar manner. Examples of label applicator stations that are configured to apply a label to a card surface are described in U.S. Pat. No. 10,369,807 and in U.S. 2024/0351349, the entire contents of each document are incorporated herein by reference.

After the label 20 is applied to the card surface 24 in the label applicator station 16, the card 22 with the label 20 attached thereto is transported into the print station 18. The print station 18 is configured to print on the face 28 of the label 20 and also print on at least a portion of the card surface 24 separate from the face 28 in a single printing pass. The print station 18 can have any configuration that is suitable for printing on both the face 28 of the label 20 and on the card surface 24. For example, the print station 18 may be configured as an inkjet printer to implement inkjet or drop-on-demand (DOD) printing using at least one inkjet or DOD printhead. Preferably multiple inkjet/DOD printheads are used. In an embodiment, the print station 18 may be configured as a direct-to-card thermal printer that includes a thermal printhead and a thermal print ribbon.

The print station 18 may be configured to perform monochromatic (i.e. single color) printing on the label and/or on the card surface to which the label is applied, or configured to perform multi-color printing. Monochromatic printing may be any single color such as black (K), yellow (Y), magenta (M), cyan (C), or specialty color such as red. The multi-color printing may be CMYK. In an embodiment, another material, such as a varnish or other non-color material, may be applied by the print station 18 onto the face of the label and/or onto the card surface.

The printing by the print station 18 on the label face 28 and on the card surface 24 separate from the label 20 may be performed in a single printing pass of the card 22 through the print station 18. In the single printing pass, the card 22 may travel through the print station 18 in a first direction (for example a direction away from the label applicator station 16 and toward the card output 14), and in the single printing pass the card 22 does not travel in a second direction opposite the first direction. During the single printing pass, the printing on the face 28 may occur prior to the printing on the card surface 24. Alternatively, during the single printing pass, the printing on the card surface 24 may occur prior to the printing on the face 28. Alternatively, during the single printing pass, at least some of the printing, or all of the printing, on the face 28 may occur simultaneously with at least some of the printing, or all of the printing, on the card surface 24.

Referring to FIGS. 1 and 3, the label 20, such as the face 28, may already have printing applied thereto, but additional printing is applied to the label 20, in particular to the face 28 thereof, in the print station 18 after the label 20 is applied to the card surface 24. In another embodiment, the label 20 may be blank when applied to the card surface 24 and the printing applied in the print station 18 is the first printing applied to the label 20.

The card surface 24 may already have some printing applied thereto when the card 22 enters the print station 18, but additional printing is applied to the card surface 24 in the print station 18. In another embodiment, the card surface 24 may be blank (i.e. without previously applied printing) and the printing applied to the card surface 24 in the print station 18 is the first printing applied to the card surface 24.

In an embodiment, a second printing pass of the card 22 through the print station 18 can be implemented to apply additional printing on the face 28 and/or to the card surface 24 to which the label is applied. The additional printing may supplement the printing applied in the first printing pass.

In an embodiment, a second printing pass through the print station 18 can be implemented to print on the card surface 26 opposite the card surface 24 to which the label is applied and/or to print on the second label 32 if applied. In this embodiment, the second printing pass may take place after flipping the card 180 degrees.

Referring to FIGS. 1 and 3, the second label 32 may be applied to the card surface 26, for example after or before the label 20 is applied to the card surface 24. In such an embodiment, the card may be flipped and returned back to the label applicator station 16 to apply the second label 32 to the card surface 26. The card 22 may then be transported into the print station 18 to print on the face 36 of the second label and/or print on the card surface 26.

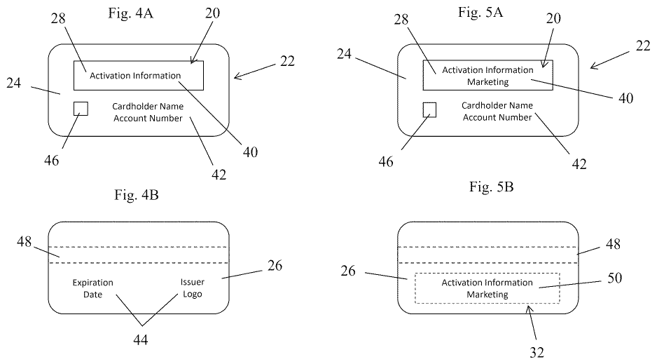

Referring to FIGS. 1 and 4A-4B, an example of the card 22 after being printed in the print station 18 in the single printing pass therethrough is depicted. The label 20 has been applied to the card surface 24 in the label applicator station 16. The print station 18 thereafter prints on the face 28 of the label 20 and also prints on the card surface 24, both of which occur in the single printing pass through the print station 18 without reversing the travel direction of the card 22. In this example, the face 28 of the label 20 is depicted as being printed with printing 40 in the form of activation information relating to activating the card 22 upon receipt by the intended cardholder. In addition, this example depicts the card surface 24 as being printed with printing 42 such as the Cardholder Name and an Account Number. The printing 40 and the printing 42 occur in the same printing pass through the print station 18. FIG. 4B depicts the card surface 26 as being printed with printing 44 including an expiration date and a card issuer logo. The printing 44 can be previously printed on the card surface 26, either in the print station 18 or in a separate print station, prior to the card surface 24 being printed in the print station 18. Alternatively, the printing 44 can be printed on the card surface 26 in a second printing pass through the print station 18 after the first printing pass. Alternatively, if a second printing mechanism is present in the print station 18, for example on an opposite side of the card travel path, the printing 44 can take place in the same single printing pass as the printing 40, 42.

FIGS. 4A and 4B further depict the card 22 as including an optional integrated circuit chip 46 and an optional magnetic strip 48. The card printing system 10 of FIG. 1 may include a chip programming station (not illustrated) that is configured to program data onto the integrated circuit chip 46. The card printing system 10 of FIG. 1 may include a magnetic strip encoding station (not illustrated) that is configured to magnetically encode data onto the magnetic strip 48.

FIGS. 5A-5B depict another example of the card 22 after being printed in the print station 18 in the single printing pass therethrough. In this example, elements that are the same as or similar to elements in FIGS. 4A and 4B are referenced using the same reference numerals. In this example, the face 28 of the label 20 is depicted as being printed with the printing 40 in the form of activation information relating to activating the card 22 upon receipt by the intended cardholder as well as marketing information, as well as printed with the printing 42. In addition, FIG. 5B depicts the optional second label 32 applied to the card surface 26. The second label 32 can be printed with printing 50. The printing 50 in this example can be activation information and/or marketing information. The printing 50 can be printed on the label 32 in a second printing pass through the print station 18 after the first printing pass. Alternatively, if a second printing mechanism is present in the print station 18, for example on an opposite side of the card travel path, the printing 50 can take place in the same single printing pass as the printing 40, 42.

FIG. 2 depicts another embodiment of a card printing system 100 that can implement the printing described herein. In this example, elements that are the same as or similar to elements in FIG. 1 are referenced using the same reference numerals. In this example, the system 100 includes the card feeder 12, the card output 14, the label applicator station 16, and the print station 18. The system 100 further includes a surface treatment station 102 and a radiation curing station 104. The stations 102, 104 are useful when the printing or other material applied by the print station 18 is radiation curable, such as ultraviolet (UV) radiation curable, which when cured helps to improve the durability of the applied printing/material.

The surface treatment station 102 is intended to treat the card surface after the label is applied to the card surface and prior to printing on the card surface. The treatment modifies the card surface making the card surface more receptive to the ink or other material subsequently applied by the print station. The surface treatment station 102 can be configured to pre-treat a desired portion of the card surface using a stream of ionized gas (or plasma) to render the treated card surface more receptive to the subsequent application of ink that is applied to the treated card surface in the print station so that the printed ink adheres better to the card surface. In an embodiment, the treatment station 102 can include a blown ion plasma system. In an embodiment, only the card surface (a portion of the card surface or the entire card surface) separate from the card label is treated, without treating the face of the label or any portion thereof. A treatment system that can treat selective portions of a card surface is described in U.S. Pat. No. 10,576,769 the entire contents of which are incorporated herein by reference. Plasma treating the face of the label may cause burning or discoloration of the label which can detract from the appearance of the label.

The radiation curing station 104 is configured with one or more radiation applicators that can emit a suitable radiation for curing the radiation curable material printed by the print station. The radiation curable material may be printed on the face of the label and/or on the card surface. In an embodiment, the radiation curable material printed by the print station may be UV curable and the radiation applicator(s) can be configured to apply UV radiation. An example of a drop-on-demand printer and a UV radiation applicator in a card printing system is the Persomaster card personalization system available from Atlantic Zeiser GmbH of Emmingen, Germany.

With continued reference to FIG. 2, if two-sided or duplex printing is required, the system 100 may also include a card flipping station 106. The card flipping station 106 can be configured to rotate the card 180 degrees so that a card surface initially facing upward (or facing to one side) now faces downward (or faces toward the opposite side). The card flipping station 106 can be located where indicated in FIG. 2 or located at other locations in the system 100.

In the case of two-sided printing on the card, the card may be returned from the card flipping station 106 to a suitable location upstream in the system 100 to implement the two-sided printing. The card may be returned back upstream in any suitable manner. For example, the card may be reversed in direction, as indicated by the double-headed arrows, from the card flipping station 106 to transport the card back to the print station 18. If a second label is to be applied to the opposite side of the card as depicted in FIG. 3, the card may be transported in reverse back to the label applicator station 16 to apply the second label to the opposite card surface. The card may then be processed like the original card surface and the first label, including treating the opposite card surface in the surface treatment station 102, printing on the second label and/or printing on the opposite card surface in the print station 18, and radiation curing in the radiation curing station 104.

The card may also be returned upstream via a card return path 108. An example of a card return path is described in U.S. Pat. No. 10,049,320 the entire contents of which are incorporated herein by reference. The card return path 108 may extend back to the label applicator station 16, back to the surface treatment station 102 or back to the print station 18, or optionally the card return path 108 may be configured to return the card selectively to any one of these stations 16, 102, 18 depending upon the processing needs of the opposite card surface. The card flipping station 106 may also be located on the card return path 108 or a separate card flipping station may be provided on the card return path 108.

With continued reference to FIG. 2, optionally one or more additional card processing stations 110 may be located in the system 100, for example between the card feeder 12 and the label applicator station 16, and optionally one or more additional card processing stations 112 may be located in the system 100, for example between the radiation curing station 104 and the card output 14. The system 100 may include the station(s) 110 but not the station(s) 112, or include the station(s) 112 but not the station(s) 110, or include any combination of the station(s) 110 and the station(s) 112.

The card processing station(s) 110, if present, may include, but are not limited to, one or more of: an integrated circuit chip programming station; a magnetic strip encoding station; an embossing station; an indenting station; a laminating station; a laser marking station; a topcoat applicator station; a security station that is configured to apply a security feature such as a holographic foil patch to the card; another print station; and other card processing stations. In the case of an integrated circuit chip programming station, the station may be configured to program a single chip on a single card at any one time, or be configured to simultaneously program the chips on multiple cards.

The card processing station(s) 112, if present, may include, but are not limited to, one or more of: an integrated circuit chip programming station; a magnetic strip encoding station; an embossing station; an indenting station; a laminating station; a laser marking station; a topcoat applicator station; a security station that is configured to apply a security feature such as a holographic foil patch to the card; another print station; a quality assurance station, such as a vision system, to check the quality of the printing and other processing on the card; and other card processing stations. In the case of an integrated circuit chip programming station, the station may be configured to program a single chip on a single card at any one time, or be configured to simultaneously program the chips on multiple cards.

A card transport system is provided that transports the cards within the card printing systems 10, 100 described herein. The card transport system can have any construction suitable for transporting the cards. Many examples of card transport systems that could be used are well known in the art. Examples of card transport systems that can be used include, but are not limited to, rollers, belts (with tabs or without tabs), carriage(s), any combinations thereof, and the like. The construction and operation of card transport systems for transporting cards between a card feeder and a card output, and through card processing stations are well known in the art.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of printing on a label applied to a card in a card printing system, wherein the card printing system comprises a print station with at least one printhead, wherein the method comprises:
supplying to the card printing system the card provided with a first surface and the label provided with a first face opposite a second face;
thereafter engaging the second face of the label on the first surface of the card so as to apply the label to the card;
thereafter in a single printing pass through the print station, printing on the first face of the label applied to the card and printing on a portion of the first surface of the card separate from the label; and
thereafter outputting the card from the card printing system.

2. The method of claim 1, wherein in the single printing pass, the card travels through the print station in a first direction, and in the single printing pass the card does not travel in a second direction opposite the first direction.

3. The method according to claim 1, wherein the label is removably engaged on the first surface of the card.

4. The method according to claim 1, further comprising performing a surface treatment on the portion of the first surface without performing a surface treatment on the first face of the label applied to the card before printing on the first face of the label and before printing on the portion of the first surface of the card.

5. The method according to claim 1, comprising printing on the first face of the label applied to the card and printing on the portion of the first surface of the card with radiation curable ink; and further comprising curing the radiation curable ink that is printed on the first face of the label applied to the card and that is printed on the portion of the first surface of the card in a radiation curing station.

6. The method according to claim 1, wherein the printing on the first face of the label applied to the card occurs prior to the printing on the portion of the first surface of the card.

7. The method according to claim 1, wherein the printing on the portion of the first surface of the card occurs prior to the printing on the first face of the label applied to the card.

8. The method according to claim 1, wherein at least some of the printing on the first face of the label applied to the card occurs simultaneously with at least some of the printing on the portion of the first surface of the card.

9. The method according to claim 1, wherein the print station comprises an inkjet printer and the at least one printhead comprises at least one inkjet printhead.

10. The method according to claim 1, further comprising:
after the single printing pass, flipping the card and transporting the flipped card to a location upstream of the at least one printhead, and thereafter printing on a second surface of the flipped card in the print station using the at least one printhead.

11. A card printing system that is configured to implement the method of claim 1.

12. A method of printing in a card printing system, wherein the card printing system comprises an inkjet printer, wherein the method comprises:
supplying to the card printing system a card provided with a first surface and a label provided with a first face opposite a second face;
thereafter engaging the second face of the label on the first surface of the card so as to apply the label to the card;
thereafter performing a surface treatment on a portion of the first surface of the card without performing a surface treatment on the first face of the label applied to the card so that the first face of the label is untreated;
thereafter using the inkjet printer to print on the untreated first face of the label applied to the card and to print on the treated portion of the first surface of the card; and
thereafter outputting the card from the card printing system.

13. The method according to claim 12, wherein the printing on the untreated first face of the label applied to the card occurs prior to the printing on the treated portion of the first surface of the card.

14. The method according to claim 12, wherein the printing on the treated portion of the first surface of the card occurs prior to the printing on the untreated first face of the label applied to the card.

15. The method according to claim 12, wherein at least some of the printing on the untreated first face of the label occurs simultaneously with at least some of the printing on the treated portion of the first surface of the card.

16. The method according to claim 12, wherein the label is removably engaged on the first surface of the card.

17. A card printing system that is configured to implement the method of claim 12.

18. A card printing system comprising:
a card feeder, a card output, a label applicator station, and a print station;
wherein the card printing system is controlled to implement a single printing pass through the print station where printing occurs on a first face of a label applied to a card and printing occurs on a portion of a first surface of the card separate from the label.
